(19) United States
(12) Patent Application Publication
(10) Pub. No.: US 2025/0229621 A1
(43) Pub. Date: Jul. 17, 2025

(54) TRANSMISSION ARRANGEMENT AND AGRICULTURAL TOWING VEHICLE

(71) Applicant: DEERE & COMPANY, MOLINE, IL (US)

(72) Inventors: MATTHIAS LANG, MANNHEIM (DE); RAINER GUGEL, PLANKSTADT (DE); DAVID MUELLER, DETTENHEIM (DE)

(21) Appl. No.: 18/984,560

(22) Filed: Dec. 17, 2024

(30) Foreign Application Priority Data
Jan. 17, 2024 (DE) 102024101325.7

(51) Int. Cl. B60K 6/365; B60K 6/48

(52) U.S. Cl. CPC B60K 6/365; B60K 2006/4841; B60Y 2200/221

(57) ABSTRACT

A transmission arrangement for a drivetrain of an agricultural towing vehicle, comprising a transmission device and a transmission unit which is positioned downstream in the power flow and which comprises a first transmission input shaft and a second transmission input shaft. The transmission device includes a mechanical transmission branch and a variable transmission branch with a magnetic-electrical epicyclic transmission stage comprising an internal rotor, an external stator and an interposed rotatable magnetic modulation ring. Electrical power of an electric machine coupled to the input shaft is able to be transmitted to the stator of the epicyclic transmission stage. The stator is able to be actuated to achieve a rotation of the modulation ring. A coupling device having a planetary transmission is arranged between the modulation ring and the two transmission input shafts.

### CROSS-REFERENCE TO RELATED APPLICATIONS

This application claims priority to German Patent Application No. 102024101325.7, filed Jan. 17, 2024, which is hereby incorporated by reference.

### TECHNICAL FIELD

The present disclosure relates generally to a transmission arrangement for a drivetrain of an agricultural towing vehicle.

### BACKGROUND

For a long time, in agricultural towing vehicles use has been made of transmission arrangements in order to be able to change the propulsion of the towing vehicle, even under high tensile load, for example caused by a work implement hitched thereto, such as a soil cultivation tool (for example a plow) or the like, by it simply being possible to change the traction motor rotational speed without interruption. In this respect, the transmission arrangement may be a powershift transmission arrangement. A known measure is to increase the number of gear ratio stages of a transmission arrangement by said arrangement comprising a combination of transmissions, for example by combining a transmission device with a transmission unit. DE 10 2013 110 709 A1 discloses such a transmission arrangement. The transmission units used in that document may in turn be known from WO 2009/050078 A2 as dual-clutch transmissions.

Alternatively, the transmission arrangement can be equipped with a continuously variable transmission. Continuously variable transmissions are implemented in power-split form with a variable hydraulic path. Here, at an input side, a proportion of the drive power is converted into hydraulic power. The proportion of the hydraulic power can be varied by means of variators. At an output side, the hydraulic energy is converted back into mechanical energy. The structural design of these continuously adjustable transmissions is associated in part with a high complexity, inertia and the development of disruptive noise.

### SUMMARY

An object of the present disclosure is to propose a transmission arrangement and an agricultural towing vehicle which largely avoid the disadvantages known from the prior art and are of a structurally simpler and more efficient design.

This object is achieved by means of a transmission arrangement having the features of one or more embodiments disclosed herein and an agricultural towing vehicle having the features of one or more embodiments disclosed herein. The one or more embodiments disclosed herein relate to particularly advantageous embodiments of the disclosure.

According to one or more embodiments disclosed herein, a transmission arrangement for a drivetrain of an agricultural towing vehicle, preferably a tractor, is proposed. The transmission arrangement comprises an input shaft, an output shaft, a transmission device and a transmission unit positioned downstream in the power flow. The transmission unit comprises a first transmission input shaft and a second transmission input shaft. The transmission device contains a mechanical transmission branch and a variable transmission branch with a magnetic-electrical epicyclic transmission stage. The epicyclic transmission stage comprises an internal rotor, an external stator and an interposed rotatable magnetic modulation ring. An electric machine coupled to the input shaft generates electrical power which is able to be partially or completely transmitted to the stator of the epicyclic transmission stage. Here, the stator of the epicyclic transmission stage is able to be actuated to achieve a rotation of the modulation ring. A coupling device having a planetary transmission is arranged between the modulation ring and the two transmission input shafts. In this case, the modulation ring is rotationally conjointly connected to a planet wheel carrier of the planetary transmission, whereas the planet wheel carrier is rotationally conjointly connected or connectable in terms of drive to the first transmission input shaft. A first sun wheel of the planetary transmission is rotationally conjointly connected or connectable in terms of drive to the second transmission input shaft.

The transmission arrangement according to the disclosure combines, in an efficient and cost-optimized manner, an electrically power-split continuously variable transmission with a transmission unit which is positioned downstream in the power flow, with interposition of a coupling device having a planetary transmission. In this case, the modulation ring advantageously acts as an input for the coupling device.

The rotatable modulation ring offers the possibility of generating different rotational speeds for transmission to the downstream transmission unit, without any notable physical moments of inertia occurring in the process. In this way, the gearshift operations can advantageously be considerably shortened and the controllability of the transmission arrangement is significantly improved.

The rotational speed-related adjustment of the modulation ring is affected by way of its rotatable position between the internal rotor and the external stator. In order to adjust the modulation ring to different rotational speeds in a technically simple manner, a variable electrical power is transmitted to the external stator. Here, the external stator can be equipped with at least one stator winding, the excitation frequency of which is able to be changed or switched. The stator is thus able to be actuated with different excitation frequencies.

The electrical power is generated by the electric machine which is coupled to the input shaft and which contributes to the implementation of the electrical variable transmission branch. For a stable generation of electrical power, the electric machine can be in a constant rotational speed ratio with the input shaft. This is achieved, for example, by a coupling with multiple toothed wheels between the input shaft and the electric machine. Alternatively, a rotor of the electric machine may be rotationally conjointly connected to the input shaft and generate an electrical power while the input shaft is being driven—in particular by an internal combustion engine.

An efficient response behavior of the modulation ring can be affected via the modulation of an electromagnetic field between the internal rotor and the external stator. To this end, the modulation ring is of magnetic design, in particular with ferromagnetic segments. The rotor is in particular of magnetic design and advantageously has a number of magnetic poles or pole pairs. The stator preferably has a number of electric poles or pole pairs for receiving the transmitted electrical power.

In addition, the stator of the epicyclic transmission stage is preferably able to be actuated in such a way that the modulation ring is rotatable in different directions of rotation in a controlled manner and the direction of rotation of the output shaft can consequently be set differently. In particular, the direction of rotation of the output shaft can be set in the opposite direction to the direction of rotation of the input shaft. An otherwise customary additional reverse gear in the transmission arrangement, in particular in the transmission unit, can be omitted as a result. The transmission arrangement can then be produced in a more compact and more inexpensive manner with a reduced number of components and requires a smaller installation space and lower maintenance effort.

The coupling device can be considered a mechanical epicyclic transmission stage which, by way of its connections to the first and the second transmission input shaft, forms two outputs. The coupling device can, in the power flow between the modulation ring and the output shaft, efficiently assist the functionality of the transmission arrangement. It is for instance possible for the torque of the modulation ring to be deflected via the coupling device completely onto the second transmission input shaft. Furthermore, the coupling device can assist a reversal of the direction of rotation between the input shaft and the output shaft. In addition, the design of the coupling device facilitates a continuously variable adjustment of rotational speed. By way of example, the output rotational speed of the transmission arrangement can be varied with constant rotational speed of the input shaft in a technically simple manner.

As already mentioned, a first sun wheel of the planetary transmission of the coupling device is rotationally conjointly connected or connectable in terms of drive to the second transmission input shaft. Preferably, a second sun wheel of the planetary transmission of the coupling device is rotationally conjointly connected to the input shaft or to an extension of the input shaft here.

Further preferably, the planet wheel carrier coupled to the modulation ring carries planet wheels of the planetary transmission of the coupling device.

In the case of a connectability in terms of drive between the first transmission input shaft and the planet wheel carrier, these are preferably connectable to one another in terms of drive by way of a clutch. In the case of a connectability in terms of drive between the second transmission input shaft and the first sun wheel of the planetary transmission, these are preferably also connectable to one another in terms of drive by way of a clutch. The first sun wheel can also be referred to simply as a sun wheel of the planetary transmission.

During shifting, the clutches can be used to bring the corresponding transmission input shaft of the transmission unit to the new rotational speed. The clutches may each be in the form of a powershiftable clutch, preferably in the form of a multi-plate clutch (or in the form of a dry single-disk clutch), particularly preferably in the form of a friction clutch. The clutches may alternatively be in the form of non-powershiftable clutches.

On the output side, the output shaft may be assigned to the transmission unit. The transmission unit may comprise the two aforementioned clutches on the input side. The clutch assigned to the first transmission input shaft can be referred to as a first clutch. The clutch assigned to the second transmission input shaft can be referred to as a second clutch.

The first clutch is in particular designed in such a way that it is movable and/or shiftable between an open state, in which the planet wheel carrier of the coupling device and thus also the modulation ring is released in terms of drive from the first transmission input shaft, and a closed state, in which the planet wheel carrier and thus also the modulation ring is in drive connection with the first transmission input shaft. The second clutch is in particular designed in such a way that it is movable and/or shiftable between an open state, in which the sun wheel assigned to the second transmission input shaft is released in terms of drive from the second transmission input shaft, and a closed state, in which this sun wheel is in drive connection with the second transmission input shaft. The first and/or the second transmission input shaft may be placed in drive connection with the output shaft. The first and/or the second transmission input shaft may be in the form of hollow shafts. Moreover, the first and/or second transmission input shaft may be arranged coaxially with one another and/or one in the other, in particular one in the other so as to be able to freely rotate. The transmission unit may comprise one or more air pressure seals which can be integrated into the output shaft and/or the first and/or second transmission input shaft.

In a preferred embodiment, a transmission control unit is provided for the transmission of the electrical power to the stator and for the actuation thereof. The transmission control unit may be assigned to the transmission arrangement, or the transmission arrangement may comprise the transmission control unit. The transmission control unit may be in the form of an electronic module with a power electronics system. The control unit may comprise a computing unit, a computer, a processor, a memory and/or all the software, hardware, algorithms, connections, in particular also sensors, that are required for the actuation of the stator of the magnetic-electrical epicyclic transmission stage and thus also for the open-loop and/or closed-loop control of the modulation ring. The transmission control unit may comprise any apparatus that can analyze data from various sensors, compare data, and make the decisions necessary to control, in open-loop and/or closed-loop fashion, and/or perform the operation of the transmission arrangement.

The transmission control unit ensures that the electrical energy or power generated by the electric machine is delivered to the stator, in particular the stator windings thereof, in the required manner. Here, the transmission control unit may be coupled to a power electronics system and/or to an energy store. The power electronics system and/or the energy store may be integrated into the transmission control unit or be actuatable as external unit(s) by the transmission control unit. Alternatively, a battery unit for storing the electrical energy generated by the electric machine may also be provided, this battery unit being able to be actuated by suitable control electronics so as to store electrical power and/or deliver it to the stator.

Furthermore, the transmission control unit may be connected, preferably in signal-connected and/or signal-transmitting and/or data-transmitting fashion, to further functional units or components of the transmission arrangement or of the towing vehicle. The control unit can be used for the open-loop and/or closed-loop control and/or actuation of the interconnected functional units or components. A connection in signal-connected and/or signal-transmitting and/or data-transmitting fashion should be understood here as meaning that signals are exchanged between the connected components. The connection can be implemented so as to be wired, i.e. in particular with cables, and/or wirelessly, i.e. by radio, for example using Bluetooth. The transmission control unit is preferably connected to a communication bus. The communication bus may for example be Isobus, CAN bus, or similar. Moreover, it is possible for a further control unit to be able to be controlled in open-loop and/or closed-loop fashion by the transmission control unit.

The transmission control unit may be assigned to the towing vehicle, in particular be arranged on the towing vehicle. The transmission control unit may alternatively be assigned to the transmission arrangement, or the transmission arrangement may comprise the transmission control unit. The transmission control unit may also be designed in two parts for example as part of the towing vehicle and as part of the transmission arrangement. The transmission control unit may be connected directly to the input and output unit which is arranged in a cab of the towing vehicle and by means of which data entered by an operator can be transmitted to the transmission control unit or be received from said transmission control unit and output. However, it is also conceivable for the transmission control unit to be connected indirectly to the input and output unit by a superordinate control unit.

Signals and data are processed in the transmission control unit. The processed signals and data are at least partially used for the required actuation of the stator or of the stator windings. In particular, the stator windings are effective as one or more exciter coil(s).

The transmission unit preferably has a reverse gear. In this way, the transmission arrangement contains an additional reverse gear, in particular in the event that the possibility of backward operation by a corresponding actuation of the stator and different directions of rotation of the modulation ring were to not be provided or were to not be sufficient. Integration of the reverse gear into the transmission unit facilitates the compatibility thereof with the power-split transmission device.

In a preferred embodiment, a transmission stage for reversing a direction of rotation is provided outside of the transmission unit. This alternative to a reverse gear in the transmission unit advantageously reduces the complexity of the transmission unit. Preferably, the transmission stage for reversing a direction of rotation is arranged between the input shaft and the magnetic-electrical epicyclic transmission stage. The transmission stage for reversing a direction of rotation makes it possible to provide forward and backward operation, without it being necessary to implement different directions of rotation of the modulation ring.

In an advantageous development of the disclosure, the transmission stage for reversing a direction of rotation comprises a planetary transmission. The functionality of the reversal of the direction of rotation can thus be provided in a compact construction and be of particularly quiet design. Preferably, the reversal of the direction of rotation at the output of the planetary transmission, that is to say in particular the sun wheel thereof, is assisted by a corresponding actuation of one or more brake apparatus(es) acting on the planetary transmission.

In one refinement of the disclosure, the transmission stage for reversing a direction of rotation comprises a clutch device positioned upstream of the planetary transmission. Said clutch device enables a reliable transmission of force and torque along the power flow in the region of the transmission stage for reversing a direction of rotation. Here, the clutch device preferably comprises, on the output side, a shaft to which a sun wheel of the planetary transmission or planetary gear set is rotationally conjointly connected.

The clutch device may be in the form of a powershiftable clutch, preferably in the form of a multi-plate clutch (or in the form of a dry single-disk clutch), particularly preferably in the form of a friction clutch. The clutch device may alternatively be in the form of a non-powershiftable clutch.

In an advantageous development of the transmission arrangement, a start-up module for electric start-up is arranged between the input shaft and the magnetic-electrical epicyclic transmission stage. This start-up module is configured for the selective coupling and decoupling of a drive connection between the input shaft and/or the electric machine and the magnetic-electrical epicyclic transmission stage (in particular the rotor thereof). This makes it possible for the primary drive (for example via an internal combustion engine and the input shaft) to be completely decoupled from the output of the towing vehicle. This enables a purely electric start-up by way of the magnetic-electrical epicyclic transmission stage, such that a high torque can be transmitted to the output. This is advantageous in particular in cases in which the towing vehicle must apply great towing forces upon start-up, that is to say at low driving speed.

In the case of the aforementioned decoupling of the drive connection, the drive (for example internal combustion engine) of the input shaft may be at a standstill. Alternatively, the drive (for example internal combustion engine) of the input shaft may be in operation, such that for example current can continue to be generated by way of the electric machine coupled to the input shaft.

In one refinement of the disclosure, the start-up module comprises a clutch unit which is drive-connected to the input shaft and/or to the electric machine on the drive side and is rotationally conjointly connected to the rotor of the magnetic-electrical epicyclic transmission stage by way of a rotor drive shaft on the output side. This assists a technically stable coupling and decoupling of the drive connection between the input shaft and/or the electric machine and the magnetic-electrical epicyclic transmission stage (in particular the rotor thereof).

The drive-side drive connection of the aforementioned clutch unit to the input shaft is preferably of rotationally conjoint design. The drive-side drive connection of the aforementioned clutch unit to the electric machine is, for example, of non-positively locking design (for example toothed wheel connection).

As an alternative or in addition to the aforementioned clutch unit, the start-up module preferably comprises a clutch unit which along the power flow is rotationally conjointly connected on one side (for example on the drive side) to the rotor of the magnetic-electrical epicyclic transmission stage by way of a rotor drive shaft and is rotationally conjointly connected on the other side (for example on the output side) to the modulation ring. A combination of the two aforementioned clutch units in the power flow provides technically simple assistance for electric start-up by way of the magnetic-electrical epicyclic transmission stage.

The aforementioned clutch units may each be in the form of a powershiftable clutch, preferably in the form of a multi-plate clutch (or in the form of a dry single-disk clutch), particularly preferably in the form of a friction clutch. The clutch units may alternatively be in the form of non-powershiftable clutches.

In a particularly advantageous refinement, that clutch unit of the start-up module which is drive-connected to the input shaft and/or to the electric machine on the drive side is effective as the clutch device of the transmission stage for reversing a direction of rotation. Here, the transmission stage for reversing a direction of rotation is arranged between the input shaft and the magnetic-electrical epicyclic transmission stage. This integration of the transmission stage for reversing a direction of rotation enables a component-saving and cost-saving implementation of the start-up module. It is for instance possible to save on a start-up module clutch unit that would otherwise be used. The clutch device of the transmission stage for reversing a direction of rotation then also assists, in an additional function, the role of the start-up module.

In a structurally advantageous embodiment, the transmission unit is designed in such a way that it has at least four gear sets for establishing gear ratio stages. Fixed wheels, for example toothed wheels, of the gear sets are rotationally conjointly arranged on the first transmission input shaft and the second transmission input shaft.

Further preferably, shift wheels, for example toothed wheels or gear-ratio toothed wheels, of the gear sets are rotatably mounted on the output shaft. The aforementioned fixed wheels can in particular at least partially be in engagement with the shift wheels. Of the at least four gear sets for establishing gear ratio stages, in particular group gear ratio stages, a first gear set and a second gear set preferably each have the fixed wheel on the first transmission input shaft and each have the shift wheel on the output shaft. Further preferably, a third gear set and a fourth gear set each have the fixed wheel on the second transmission input shaft and each have the shift wheel on the output shaft.

The first transmission input shaft and/or the second transmission input shaft may be arranged axially parallel to and/or coaxially with one another.

Specifically, the transmission unit may comprise exactly two transmission input shafts, i.e. the first and the second transmission input shaft, and exactly one output shaft. Moreover, the transmission unit may comprise exactly four gear sets. The first gear set may comprise a first fixed wheel of the first transmission input shaft, said first fixed wheel meshing with a first shift wheel of the output shaft. The second gear set may comprise a second fixed wheel of the first transmission input shaft, said second fixed wheel being able to be in engagement with a second shift wheel of the output shaft. The third gear set may comprise a third fixed wheel of the second transmission input shaft, said third fixed wheel being able to mesh with a third shift wheel of the output shaft. The fourth gear set may comprise a fourth fixed wheel of the second transmission input shaft, said fourth fixed wheel being able to be in engagement with the shift wheel, in particular a fourth shift wheel, of the output shaft.

In a further refinement of the disclosure, the transmission unit comprises a shift element for coupling two shift wheels, the shift element in particular being able to be rotatably mounted on the output shaft or being able to be non-rotationally conjointly connected to the output shaft. In this case, the shift wheel of the second gear set and the shift wheel of the third gear set are able to be coupled, preferably selectively coupled, to the shift element in such a way that at least one winding path gear ratio stage is able to be formed via the second and the third gear set. In this respect, the shift wheel of the second gear set and the shift wheel of the third gear set may be couplable in particular in combination with the first or the fourth gear set, that is to say in particular when the first or the fourth gear set is also fixed to the output shaft by a coupling element. In other words, the shift wheel of the second gear set, the shift wheel of the third gear set and the shift element may be arranged on the output shaft in such a way, and in particular the shift wheel of the second gear set and the shift wheel of the third gear set may be connectable and releasable by means of the shift element in such a way, that at least one winding path gear ratio stage is able to be shifted via the shift element. Here, the power flow of the winding path gear ratio stage may wind via at least three gear sets with intermeshing fixed wheels and shift wheels.

If a winding path gear ratio stage is shifted, two of the shift wheels, that is to say in particular the second and the third shift wheel, can be rotationally conjointly connected to one another by the shift element and at the same time the first or the fourth gear set can be activated, that is to say at the same time the first shift wheel can be connected to the output shaft by a first coupling element or the fourth shift wheel can be connected to the output shaft by a second coupling element. The transmission unit may thus specifically comprise six gear ratio stages or group gear ratio stages, which in particular are powershiftable. The transmission unit may thus comprise four gear ratio stages which are shiftable only via one gear set and two gear ratio stages which are shiftable as winding path gear ratio stages. In addition, the second and the third shift wheel may be couplable in such a way that, in particular when the first or the fourth gear set is also fixed to the output shaft by a coupling element, two further gear ratio stages can be implemented as winding path gear ratio stages. The first and the sixth gear ratio stage may preferably be a winding path gear, that is to say be implemented as a winding path gear ratio stage. The size of the steps between the individual gear ratio stages A to F may be constant and/or lie in a range of 1.2 to 2.4, preferably in a range of 1.46 to 2.14, particularly preferably may be 1.77.

The transmission unit in particular comprises exactly one shift element, in particular for coupling the shift wheels of the second and third gear set. For this purpose, the shift element may be arranged on the output shaft between the second and the third gear set, and in particular be rotatably mounted on the output shaft. The two shift wheels may be rotationally conjointly and releasably connectable to the shift element, the two coupled shift wheels in particular being able to be rotatably and/or loosely arranged on the output shaft. Here, the two rotatably mounted shift wheels of the second and the third gear set may be couplable via the shift element in such a way that a rotationally conjoint connection is able to be produced depending on a shift state of the shift element between the two shift wheels, with the result that the two shift wheels are rotatable at the same rotational speed. In other words, the two shift wheels may be connected to the shift element in such a way that the first and the second transmission input shaft can be placed in dependence on one another. Specifically, in the case of a winding path gear ratio stage, the shift wheel of the second gear set and the shift wheel of the third gear set are thus coupled to one another in order to implement a common force flow and power flow through the first and the second transmission input shaft as a result.

Advantageously, winding path gear ratio stages are implemented with the discussed transmission unit. Owing to the multiple uses of individual gear sets, components savings in the structural design of the transmission unit are possible. Since the transmission unit in particular is a transmission (e.g. dual-clutch transmission) which comprises two winding path gear ratio stages and is shiftable into different transmission ratios, preferably is shiftable into six gear ratio stages, it is thus advantageously possible to implement a maximum number of gear ratio stages with a minimum number of shafts and toothed wheels in the transmission unit. This advantageously makes it possible to achieve a minimal installation space or structural space in the agricultural towing vehicle and an optimally structurally simple design of the transmission unit. Advantageously, the transmission unit also makes it possible to perform powershifts. It is moreover possible, in comparison with transmission units with a comparable number of shafts and toothed wheels, to implement additional transmission ratios, such that the transmission arrangement according to the disclosure achieves improved transmission spread and more gear ratio stages. Moreover, higher driving speeds and low start-up speeds are enabled, as a result of which operation at slow speeds can be implemented with the towing vehicle. The structurally simple way in which the transmission unit is designed makes it possible to save on additional gear stages, as a result of which weight and thus fuel costs are in turn saved. Moreover, the smaller installation space makes it possible for the towing vehicle to become more agile and more compact on account of the shorter distance between wheels and/or for the saved installation space to be able to be used for other functions/assemblies. A further substantial advantage are the shorter gear sets, as a result of which shorter shafts can be used. Shorter shafts in turn ensure less shaft bending and thus a longer bearing and toothing service life.

In one refinement of the disclosure, the shift element is movable between a first shift position, in which the shift wheel of the second gear set and the shift wheel of the third gear set are coupled, and a second shift position, in which the shift wheel of the second gear set and the shift wheel of the third gear set are released from one another. This advantageously achieves the advantages stated above.

In an exemplary embodiment which is advantageous from a structural perspective, the transmission unit comprises one or more coupling elements, in particular exactly two coupling elements, that is to say for example a first and a second coupling element, the shift wheels being able to be rotationally conjointly and releasably connected to the output shaft by means of one of the coupling elements, in particular each of the shift wheels being able to be rotationally conjointly and releasably connected to the output shaft by means of one of the coupling elements.

The coupling element or elements may be rotationally conjointly and axially displaceably mounted on the output shaft and/or be movable, in particular axially movable, by means of an actuating element, and/or the coupling elements are arranged between in each case two shift wheels, in particular the fixed wheels associated with the shift wheels being arranged on the same transmission input shaft, that is to say the first or the second transmission input shaft.

The coupling elements may be designed in a form known per se as dog clutches or actuating apparatuses, in particular sliding sleeves, and shift assemblies, comprising synchronizing rings, or synchronizers. In any case, the coupling elements are coupling means which are rotationally conjointly and axially displaceably arranged on the output shaft and by means of which the shift wheels are able to be rotationally conjointly connected to the output shaft for the purpose of activating a transmission ratio. The axial displacement of the coupling elements may be affected via the actuating element. To that end, the transmission unit may comprise corresponding actuating elements or in particular each coupling element may comprise a respective actuating element.

In one refinement of the disclosure, the highest gear ratio stage and the lowest gear ratio stage are implemented as winding path gear ratio stages and/or the highest gear ratio stage utilizes, among other things, the gear set of the previous gear ratio stage and/or the lowest gear ratio stage utilizes, among other things, the gear set of the next highest gear ratio stage. However, in this embodiment variant other assignments of the gear ratio stages with respect to the first and the second clutch are also possible. In particular, it is possible to implement a reverse assignment in a very simple way, e.g. by way of a mirrored arrangement. Advantageously, with the winding path gear ratio stage, in the lowest gear ratio stage the transmission ratio is a product of three transmission ratio stages, as a result of which a larger transmission ratio can be achieved than by just one transmission ratio using one gear set. This enables a lowest gear at slower speeds than without a winding path gear ratio stage. It is also advantageous that additionally, in combination with the winding path gear ratio stage, in the highest gear ratio stage the transmission ratio is likewise a product of three transmission ratio stages and in the highest gear ratio stage higher speeds can be achieved than without a winding path gear ratio stage. This enables a highest gear at higher speeds than without a winding path gear ratio stage.

In one refinement of the disclosure, the transmission unit comprises six gear ratio stages, preferably exactly six gear ratio stages, particularly preferably exactly six powershiftable gear ratio stages, and/or the first and the sixth gear, that is to say the lowest and the highest gear, are implemented as a winding path gear ratio stage. This advantageously achieves optimum transmission stepping, which is ideal for the full scope of operating ranges of agricultural towing vehicles.

In a particularly advantageous refinement, a rear-axle bevel gear drive is connected, in particular rotationally conjointly connected, to the output shaft. Advantageously, on account of the direct connection of the output shaft to the rear-axle bevel gear drive, it is possible to save on expensive connecting elements, for example an articulated shaft, that tend to need maintenance. Moreover, the output shaft is preferably connected to a toothing of a front-axle drive. To that end, a front-axle drive wheel may be connected to the output shaft, in particular rotationally conjointly connected to the output shaft, or selectively rotationally conjointly connectable thereto and releasable therefrom. Advantageously, the front-axle drive may thus be connected to the rear-axle bevel gear drive by means of the output shaft. Moreover, advantageously the output shaft additionally takes on the function of connecting a front and rear vehicle axle, as a result of which it is possible to save on a further connecting element. Similarly, the output shaft may be connected to a parking lock wheel.

In one refinement of the disclosure, the pinion of the rear-axle bevel gear drive is in the form of part of the output shaft, in particular is integrated into the output shaft. Advantageously, this makes it possible to achieve a very compact construction, which saves on structural space and transmission length.

An advantageous development of the transmission arrangement provides that a power take-off drive shaft (PTO drive shaft) is arranged in the first and the second transmission input shaft. The power take-off drive shaft may be embodied as a solid shaft. The transmission unit, but in particular also the transmission arrangement, may thus have a shaft leadthrough for a power take-off drive of the agricultural vehicle. To that end, the first and the second transmission input shaft of the transmission unit may be embodied as hollow shafts and may incorporate the power take-off drive shaft for the purpose of driving a power take-off transmission. Expediently, the first clutch and the second clutch, in the case of the use thereof on the input side of the transmission unit, may also have a central passage for the power take-off drive shaft. In this way, direct and thus particularly energy-efficient drive-power transmission from the traction motor to a power take-off shaft output of the tractor is possible.

The disclosure also relates to an agricultural towing vehicle, preferably a tractor, having a transmission arrangement in one or more embodiments disclosed herein. The agricultural towing vehicle may moreover comprise a traction motor, in particular an internal combustion engine. In this case, the transmission arrangement may be drivable by the traction motor and be in drive connection with at least one vehicle axle of the towing vehicle and/or may be able to be placed in drive connection with a further drive axle of the towing vehicle. The towing vehicle according to the disclosure has the above-described advantages of the transmission arrangement according to the disclosure.

The transmission arrangement according to the disclosure and the towing vehicle according to the disclosure enable an efficient combination of a power-split transmission device with a downstream transmission unit, which can be in the form of a full powershift transmission. The transmission unit used in the context of the transmission arrangement according to the disclosure advantageously has a considerably narrower construction and manages with little structural space, weight and rotational inertia, in comparison with conventional transmissions, in particular powershift transmissions (PST), as are used in large towing vehicles. As a result, the construction is more cost-effective and provides greater savings on fuel owing to better efficiency. In comparison with various partial powershift transmissions (PPST), as are used in various medium and smaller towing vehicles, in this respect the functionality toward fully powershiftable transmissions can be improved. Advantageously, in particular when shifting over from one group to the next, it is possible to achieve that the towing force is no longer interrupted and work can be continued at full load, both in the field and during transport. This is done with reduced additional weight and structural space requirements, in particular compared to conventional, fully powershiftable transmissions, despite the same degree of performance being attained.

Other features and aspects will become apparent by consideration of the detailed description, claims, and accompanying drawings.

### BRIEF DESCRIPTION OF THE DRAWINGS

The transmission arrangement according to the disclosure will be explained in more detail below with reference to the appended drawings. Components of equivalent or comparable function are identified by the same reference signs.

FIG. 1 shows a schematic illustration of an agricultural towing vehicle according to the disclosure.

FIG. 2 shows a schematic illustration of a first exemplary embodiment of the transmission arrangement according to the disclosure.

FIG. 3 shows a schematic illustration of a further exemplary embodiment of the transmission arrangement according to the disclosure.

FIG. 4 shows a schematic illustration of a further exemplary embodiment of the transmission arrangement according to the disclosure.

FIG. 5 shows a schematic illustration of a further exemplary embodiment of the transmission arrangement according to the disclosure.

FIG. 6 shows a schematic illustration of a further exemplary embodiment of the transmission arrangement according to the disclosure.

Like reference numerals are used to indicate like elements throughout the several figures.

### DETAILED DESCRIPTION

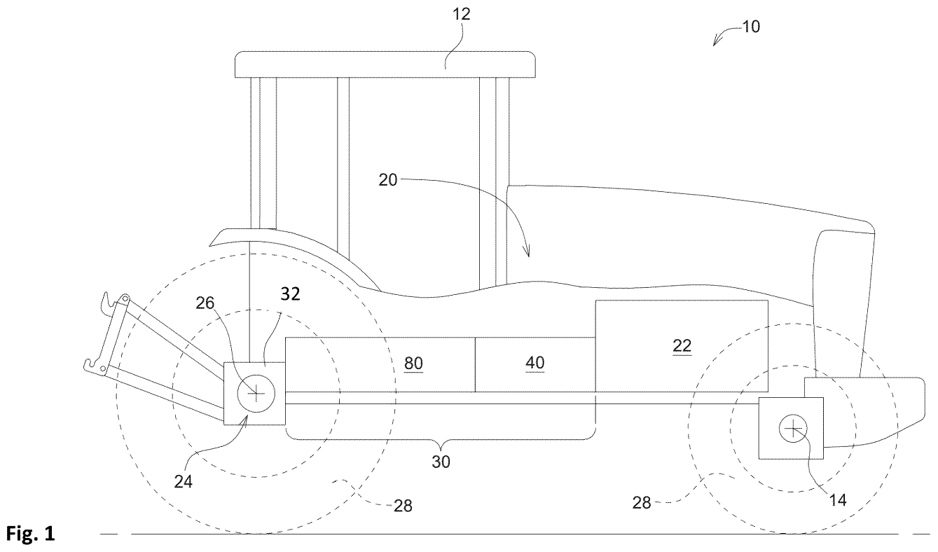

FIG. 1 shows a schematic illustration of an agricultural towing vehicle 10 according to the disclosure, in particular in the form of a tractor, with a drivetrain 20 in one possible refinement. The basic design of an agricultural towing vehicle 10 is assumed to be known to a person skilled in the art. The towing vehicle 10 also comprises a cab 12, a front vehicle axle 14 and a rear vehicle axle 26. The front vehicle axle 14 and the rear vehicle axle 26 are part of the drivetrain 20, with it being possible for the rear vehicle axle 26 generally to be permanently driven and the front vehicle axle 14 generally to be activatable on demand.

The drivetrain 20 also comprises a traction motor 22, which may be embodied as an internal combustion engine, and a transmission structure which may be composed of various individual transmission components, as described below. The transmission structure described in the present case, in terms of the force flow and torque flow and taking the traction motor 22 as a starting point, may have a transmission arrangement 30 according to the disclosure, a traction drive 24 and a rear-axle transmission 32. The transmission arrangement 30 comprises a transmission device 40 and a transmission unit 80. Here, the transmission device 40 is positioned downstream of the traction motor 22. The transmission device 40 is drive-connected to the traction motor 22 and/or may be drivable by the traction motor 22. The transmission unit 80 is positioned downstream of the transmission device 40. Here, the transmission unit 80 is drive-connected to the transmission device 40 and/or is drivable by the transmission device 40.

The transmission arrangement 30 shown makes it possible to transmit drive power from the traction motor 22 to an output shaft 90 of the transmission unit 80 with different gear ratio stages. The rear vehicle axle 26, which is in drive connection with the output shaft 90 and converts rotation of the front and/or the rear vehicle axle (via ground engagement means connected thereto) into propulsion of the tractor, is therefore driven at a different rotational speed depending on a gear ratio stage selected in the transmission arrangement 30. Consequently, a tractor equipped with the transmission arrangement 30 is movable in different speed ranges depending on the gear ratio stage selected in the transmission arrangement 30.

The towing vehicle 10 may have one or more ground engagement means in the form of wheels 28 which are in engagement with an underlying surface to transmit drive forces and/or by way of which the towing vehicle 10 is supported on the underlying surface. The towing vehicle 10 may moreover have a chassis, it being possible for the chassis in particular to be borne by the wheels 28 suspended on the front and the rear vehicle axle 14, 26.

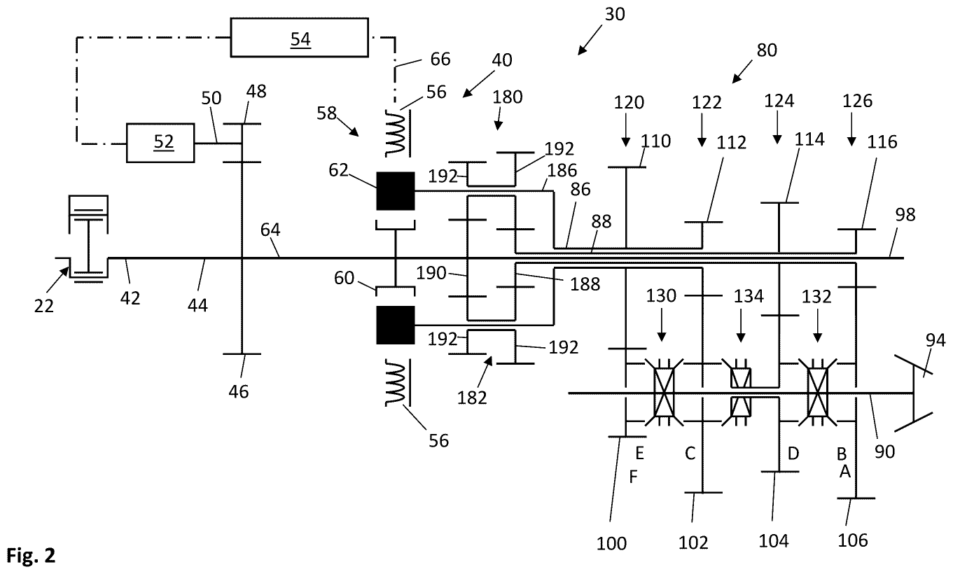

FIG. 2 shows a schematic illustration, in particular a line diagram, of a first exemplary embodiment of the transmission arrangement 30 according to the disclosure. The transmission arrangement 30 shown in FIG. 2 is a detailed schematic illustration of the transmission arrangement 30 shown in FIG. 1. Therefore, only details not shown in FIG. 1 will be discussed below. As already mentioned, the transmission arrangement 30 comprises the transmission device 40 and the transmission unit 80 positioned downstream in the power flow.

The transmission unit 80 comprises a first transmission input shaft 86 and a second transmission input shaft 88 and the output shaft 90, in particular one output shaft 90. A rear-axle bevel gear drive 94 is connected to the output shaft 90. In this case, the pinion of the rear-axle bevel gear drive 94 may be in the form of part of the output shaft 90, in particular may be integrated into the output shaft 90.

Moreover, the first and/or the second transmission input shaft 86, 88 are in the form of hollow shafts and the second transmission input shaft 88 is arranged in the first transmission input shaft 86. Furthermore, the first and/or the second transmission input shaft 86, 88 incorporate a power take-off drive shaft 98 for driving a power take-off transmission.

Four shift wheels 100, 102, 104, 106 are rotatably mounted on the output shaft 90. In total, four fixed wheels 110, 112, 114, 116 are rotationally conjointly arranged on the first and the second transmission input shaft 86, 88, in particular are rotationally conjointly connected to the first and the second transmission input shaft 86, 88. In this case, the first and the second transmission input shaft 86, 88 are each assigned two fixed wheels. These each mesh with one of the shift wheels 100, 102, 104, 106 assigned to the output shaft 90. The transmission unit 80 has multiple gear sets, in particular four gear sets 120, 122, 124, 126, for establishing gear ratio stages B, C, D, E. To that end, at least one first gear set 120 and one second gear set 122 each have the fixed wheel 110, 112 on the first input shaft 86 and each have the shift wheel 100, 102 on the output shaft 90. Moreover, at least one third gear set 124 and one fourth gear set 126 each have the fixed wheel 114, 116 on the second input shaft 88 and each have the shift wheel 104, 106 on the output shaft 90. Specifically, the first gear set 120 comprises a first fixed wheel 110, which meshes with a first shift wheel 100 on the output shaft 90. The second gear set 122 comprises a second fixed wheel 112, which is in engagement with a second shift wheel 102. The third gear set 124 comprises a third fixed wheel 114, which meshes with a third shift wheel 104. The fourth gear set 126 comprises a fourth fixed wheel 116, which is in engagement with a fourth shift wheel 106.

The dimensioning of the gear sets 120, 122, 124, 126 is not necessarily to scale in relation to one another. Rather, the actual radii of the fixed wheels 110, 112, 114, 116 and of the shift wheels 100, 102, 104, 106 may be dimensioned differently and in a manner that is suitable for the transmission unit 80 and the transmission arrangement 30.

The transmission unit 80 also comprises exactly two coupling elements 130, 132, that is to say a first coupling element 130 and a second coupling element 132. The first coupling element 130 is arranged between the first and the second gear set 120, 122 and the second coupling element 132 is arranged between the third and the fourth gear set 124, 126 on the output shaft 90. The shift wheels 100, 102, 104, 106 are rotationally conjointly and releasably connectable to the output shaft 90 by means of the first or the second coupling element 130, 132. Specifically, the first shift wheel 100 or the second shift wheel 102 is thus rotationally conjointly and releasably connectable to the output shaft 90 by means of the first coupling element 130. Moreover, the third shift wheel 104 or the fourth shift wheel 106 is rotationally conjointly and releasably connectable to the output shaft 90 by means of the second coupling element 132. A respective coupling element 130, 132 is thus arranged between in each case two shift wheels 100, 102, 104, 106. The first and the second coupling element 130, 132 are rotationally conjointly and axially displaceably mounted on the output shaft 90. The first and the second coupling element 130, 132 are in the form of shift assemblies, which comprise actuating apparatuses, in particular sliding sleeves, and synchronizing rings. As a result, the rotatably mounted shift wheels 100, 102, 104, 106 are shiftable via the coupling elements 130, 132, and therefore a respective fixed rotational speed ratio is able to be established between the output shaft 90 and the respective first and/or second transmission input shaft 86, 88 depending on a shift state of the coupling elements 130, 132.

The transmission unit 80 moreover comprises a shift element 134 for coupling two shift wheels 102, 104. Specifically, the second and the third shift wheel 102, 104 are able to be coupled to the shift element 134. The second and the third shift wheel 102, 104 are rotationally conjointly and releasably connectable to the shift element 134. The second and the third shift wheel 102, 104 are able to be coupled, in particular selectively coupled, to the shift element 134 in such a way that at least one winding path gear ratio stage A, F is able to be formed via the second and the third gear set 122, 124, i.e. in particular the first and the second transmission input shaft 86, 88 are thus able to be coupled to one another. In other words, the shift element 134 may in particular be movable between a first shift position, in which the second shift wheel 102 and the third shift wheel 104 are coupled, and a second shift position, in which the second shift wheel 102 and the third shift wheel 104 are released from one another. The shift element 134 is in the form of a synchronizer acting on one side. The shift element 134 is arranged between the first and the second coupling element 130, 132 along the output shaft 90.

Depending on the shift state of the first and the second coupling element 130, 132 and of the shift element 134, the transmission unit 80 can be shifted with each of the transmission input shafts 86, 88 in in each case two gear ratio stages, i.e. a total of four gear ratio stages B, C, D, E, and in each case an additional gear ratio stage as a winding path gear ratio stage A, F, i.e. a total of two winding path gear ratio stages A, F, and thus shifted in a total of six gear ratio stages or group gear ratio stages. Here, the transmission unit 80 can be shifted by virtue of the shift element 134 and the first and second coupling element 130, 132 being correspondingly activated, in particular actuated, at the synchronization point of the two transmission input shafts 86, 88 and the power flow and the torque in the coupling device 180 thus being automatically diverted to the new shifted path. To select a desired gear ratio stage, the shift wheel in question, that is to say in particular the first to the fourth shift wheel 100, 102, 104, 106, is rotationally conjointly connected to the output shaft 90 by the respectively assigned first or second coupling element 130, 132, with the result that the gear ratio stages B, C, D, E are implemented. If a gear ratio stage A, F as a winding path gear ratio stage is shifted, the second and the third shift wheel 102, 104 are rotationally conjointly connected to one another by the shift element 134 and at the same time the gear ratio stage E or B is activated, that is to say at the same time the first shift wheel 100 is connected to the output shaft 90 by the first coupling element 130 (gear ratio stage E) or the fourth shift wheel 106 is connected to the output shaft 90 by the second coupling element 132 (gear ratio stage B). Consequently, each winding path gear ratio stage runs over three gear sets. The transmission unit 80 thus comprises six gear ratio stages, which in particular are powershiftable. Specifically, the first and the sixth gear ratio stages A, F are a winding path gear, i.e. implemented as winding path gear ratio stages.

The transmission arrangement 30 comprises essentially two functional groups 40, 80, which are in drive connection with one another via the coupling device 180. The transmission device 40 is arranged on the input side of the transmission arrangement 30. The transmission device 40 may be in drive connection with the traction motor 22 and be drivable by the traction motor 22. The transmission unit 80 comprises the output shaft 90, which at the same time is the drive output shaft of the transmission arrangement 30, on the output side.

A motor drive output shaft 42 on the internal combustion engine 22 is in particular rotationally conjointly extended along the power flow and forms in this extension an input shaft 44 for the transmission arrangement 30. The input shaft 44 may supply the power take-off drive shaft 98 with drive power and is, to this end, in the form of a continuous shaft in an axial direction.

A drive wheel 46 is rotationally conjointly arranged on the input shaft 44 and meshes with a further drive wheel 48. The drive wheel 48 is rotationally conjointly arranged on a drive shaft 50 which is in an in particular releasable drive connection with an electric machine 52. This makes it possible for the internal combustion engine 22 and the electric machine to be in a constant rotational speed ratio. As long as the electric machine 52 is in drive connection with the input shaft 44, a proportion of mechanical energy or power of the internal combustion engine is converted into electrical energy or power. The remaining mechanical proportion in the input shaft 44 is transmitted by the latter. Electrical power generated by the electric machine 52 can be transmitted controlled by a transmission control unit 54 in a variable manner to a stator 56 of a magnetic-electrical epicyclic transmission stage 58. The transmission control unit 54 may be combined with a power electronics system and/or a battery unit or may comprise such a power electronics system and/or battery unit. Depending on the power requirement at the stator 56, the electrical power of the electric machine 52 may first be stored temporarily or be transmitted directly to the stator 56.

The magnetic-electrical epicyclic transmission stage 58 comprises the external stator 56, an internal rotor 60 and an interposed rotatable magnetic modulation ring 62. The internal rotor 60 is rotationally conjointly connected to the input shaft 44. The modulation ring 62 is rotationally conjointly connected to a planet wheel carrier 186 of the planetary transmission 182 of the coupling device 180. The planet wheel carrier 186 in turn is rotationally conjointly connected to the first transmission input shaft 86. A first sun wheel 188 of the planetary transmission 182 is rotationally conjointly connected to the second transmission input shaft 88. A second sun wheel 190 of the planetary transmission 182 is rotationally conjointly connected to the input shaft 44 and thus also to the rotor 60. The planet wheel carrier 186 carries planet wheels 192 of the planetary transmission 182.

The design of the transmission device 40 is of power-split form with a mechanical transmission branch 64 in the region of the continuous input shaft 44 and with an electrical or variable transmission branch 66 contained in the magnetic-electrical epicyclic transmission stage 58. Both the rotating rotor 60 and the electrically actuated stator 56 influence the rotation of the modulation ring 62. This makes it possible to variably set an outgoing rotational speed and an outgoing torque at the modulation ring 62. The rotational speed or the drive power at the modulation ring 62 can be adapted by virtue of the excitation frequency of the winding(s) on the external stator 56 being changed by the transmission control unit 54. During this change, essentially no moment of inertia is produced, and therefore a change in the moment of inertia of the transmission arrangement 30 is kept very small and changes in speed during the gearshift operations are no longer perceptible. The inertia-free change in rotational speed at the modulation ring contributes to achieving harmonious jerk-free operation during the gearshift operations.

The variable setting of the rotatable modulation ring 62 by the transmission control unit 54 also enables a reversal of the direction of rotation of the modulation ring 62. In other words, the stator 56 is able to be actuated to obtain a direction of rotation of the output shaft 90 in the opposite direction to the direction of rotation of the input shaft 44, and therefore forward and backward operation of the transmission arrangement 30 is possible by way of the epicyclic transmission stage 58.

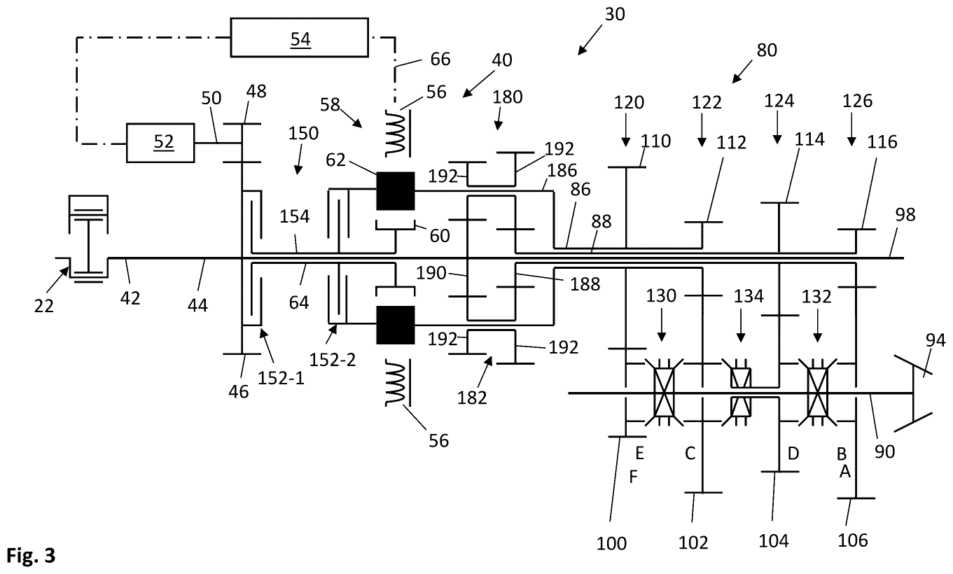

FIG. 3 shows a schematic illustration, in particular a line diagram, of a further exemplary embodiment of the transmission arrangement 30 according to the disclosure. Here, the transmission unit 80 corresponds substantially to the transmission unit 80 shown in FIG. 2, and therefore only details and/or differences in the transmission device 40 are discussed below. In FIG. 3, a start-up module 150 for electric start-up is arranged between the input shaft 44 and the magnetic-electrical epicyclic transmission stage 58. For this purpose, the start-up module 150 comprises a first clutch unit 152-1 and a second clutch unit 152-2. The first clutch unit 152-1 is rotationally conjointly connected to the input shaft 44 on the drive side and is rotationally conjointly connected to the rotor 60 of the epicyclic transmission stage 58 by way of a rotor drive shaft 154, in the form of a hollow shaft, on the output side. Along the power flow, the second clutch unit 152-2 is rotationally conjointly connected to the rotor drive shaft 154 on one side and is rotationally conjointly connected to the modulation ring 62 on the other side.

With the first clutch unit 152-1, it is selectively possible to implement coupling and decoupling of the in particular mechanical drive connection between the input shaft 44 and the epicyclic transmission stage 58. In a closed state of the first clutch unit 152-1, the input shaft 44 and the rotor 60 are in drive connection with one another via the rotor drive shaft 154, and therefore the mechanical transmission branch 64 is effective for the modulation ring 62.

In the open state of the first clutch unit 152-1 illustrated in FIG. 3, the modulation ring 62 is decoupled from the mechanical transmission branch 64, enabling a purely electric start-up via the variable transmission branch 66. Here, electrical energy is transmitted to the stator 56 by the transmission control unit 54 and/or via a battery unit. In particular, a constant rotational speed ratio between the rotor 60 and the modulation ring 62 is also produced here. This is achieved by a corresponding actuation of the second clutch unit 152-2. Electric start-up is particularly advantageous in the case of high trailer loads, which usually require a significant reduction ratio at low driving speeds in order to start up.

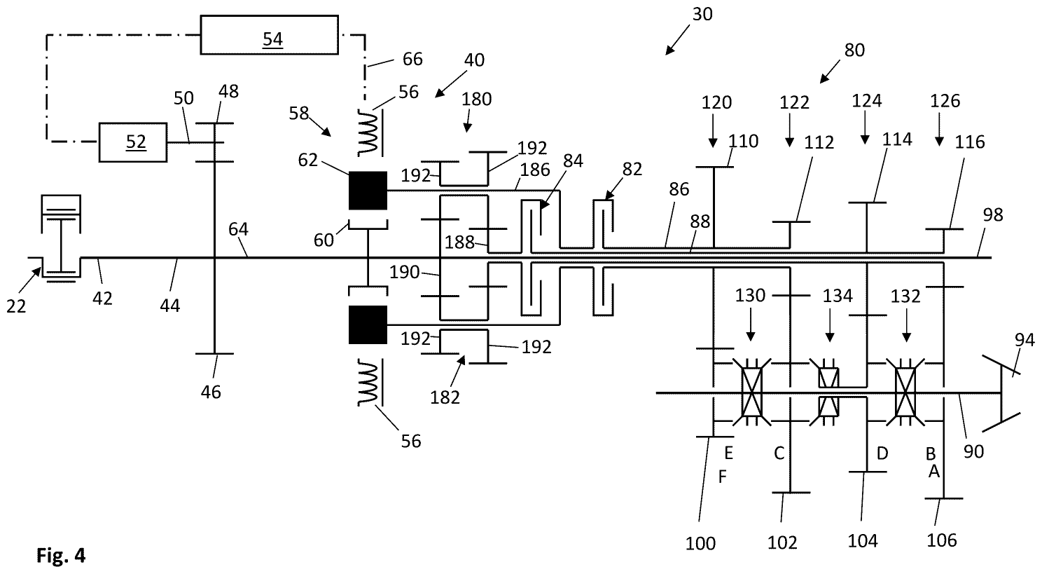

FIG. 4 shows a schematic illustration, in particular a line diagram, of a further exemplary embodiment of the transmission arrangement 30 according to the disclosure. It differs from the transmission arrangement 30 according to FIG. 2 essentially in that the coupling device 180 is connectable in terms of drive to the two transmission input shafts 86, 88 via two clutches 82, 84. More precisely, the first transmission input shaft 86 and the planet wheel carrier 186 are connectable in terms of drive via a first clutch 82. The second transmission input shaft 88 and the first sun wheel 188 are connectable in terms of drive via a second clutch 84.

The output side of the first clutch 82 is connected to the first transmission input shaft 86, in particular the first clutch 82 is rotationally conjointly connected to the first transmission input shaft 86. The output side of the second clutch 84 is connected to the second transmission input shaft 88, in particular the second clutch 84 is rotationally conjointly connected to the second transmission input shaft 88. The first and the second clutch 82, 84 are movable or shiftable between an open state, in which the planet wheel carrier 186 or the first sun wheel 188 is released in terms of drive from the first or, respectively, second transmission input shaft 86, 88, and a closed state, in which the planet wheel carrier 186 or the first sun wheel 188 is in drive connection with the first or, respectively, second transmission input shaft 86, 88.

Depending on the shift state of the first and the second clutch 82, 84 and on the shift state of the first and the second coupling element 130, 132 and of the shift element 134, the transmission unit 80 can be shifted with each of the clutches 82, 84 in two gear ratio stages, i.e. a total of four gear ratio stages B, C, D, E, and in each case an additional gear ratio stage as a winding path gear ratio stage A, F, i.e. a total of two winding path gear ratio stages A, F, and thus shifted in a total of six gear ratio stages or group gear ratio stages. In this case, the transmission unit 80 can be shifted under load in that while one clutch, for example the first clutch 82, is being opened, the other clutch, for example the second clutch 84, is closed, with the result that a drive connection existing between the first or the second transmission input shaft 86, 88 and the coupling device 180 is able to be replaced by a drive connection to be established via the respectively other transmission input shaft 86, 88, without interrupting a drive connection between the first or the second transmission input shaft 86, 88 and the output shaft 90.

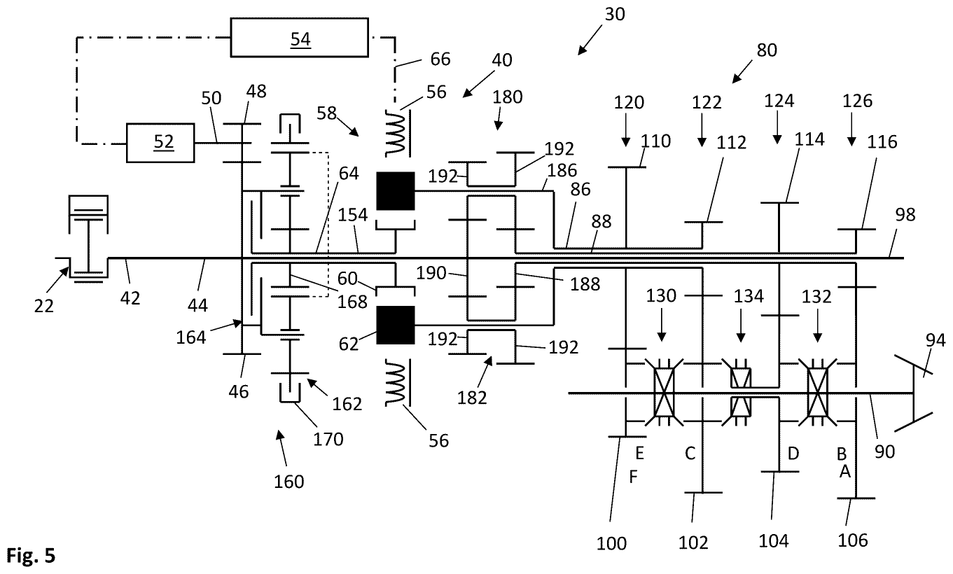

FIG. 5 shows a schematic illustration, in particular a line diagram, of a further exemplary embodiment of the transmission arrangement 30 according to the disclosure. It differs from the transmission arrangement 30 according to FIG. 2 essentially in that a transmission stage 160 for reversing a direction of rotation is integrated in the transmission device 40. The transmission stage 160 in FIG. 5 is arranged between the input shaft 44 and the epicyclic transmission stage 58.

The transmission stage 160 comprises a planetary transmission 162 and a clutch device 164 positioned upstream of the planetary transmission 162. In this case, the clutch device 164 is rotationally conjointly connected to the input shaft 44 on the drive side and is rotationally conjointly connected to the rotor 60 of the epicyclic transmission stage 58 by way of a rotor drive shaft 154 on the output side. Actuation of the clutch device 164 between an open and a closed state and/or actuation of a brake apparatus 170 on the planetary transmission 162 makes it possible to orient the direction of rotation of the transmission input shafts 86, 88 oppositely in comparison to the direction of rotation of the input shaft 44 and thus to provide forward and backward operation of the transmission arrangement 30. In particular, a change in direction of rotation of the magnetic rotor 60 can generate or assist a change in direction of rotation of the modulation ring 62 and thus also of the transmission input shafts 86, 88.

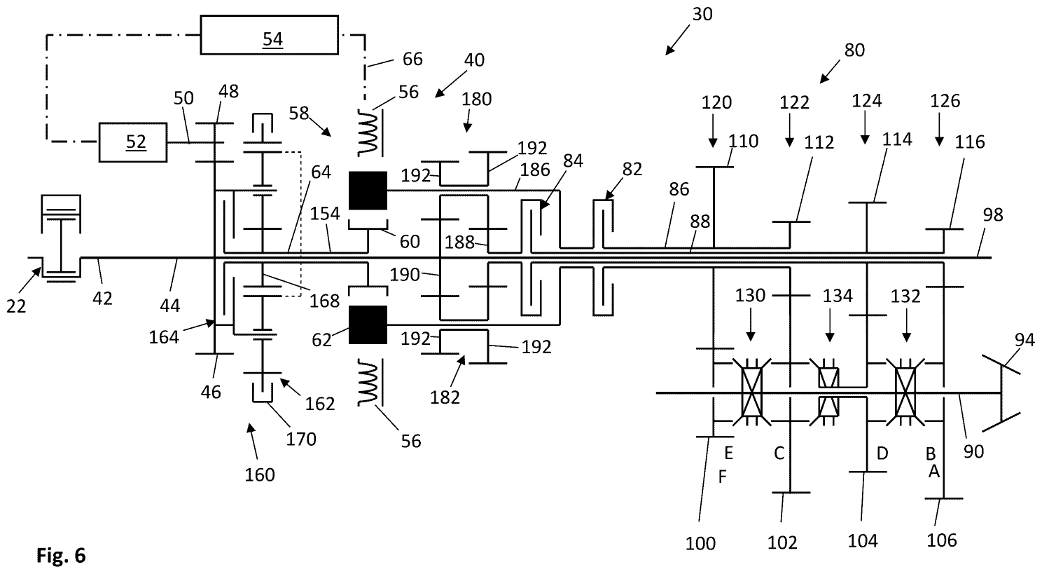

FIG. 6 shows a schematic illustration, in particular a line diagram, of a further exemplary embodiment of the transmission arrangement 30 according to the disclosure. It differs from the transmission arrangement 30 according to FIG. 5 essentially in that the clutches 82, 84 already disclosed in FIG. 4 are additionally integrated.

In further preferred embodiments that are not illustrated here, the clutches 82, 84 disclosed in FIG. 4 and FIG. 6 can also be implemented in the embodiments of the transmission arrangement 30 according to FIG. 2, FIG. 3 and FIG. 5.

Furthermore, in further preferred embodiments that are not illustrated here, the transmission devices 40 according to FIG. 5 and according to FIG. 6 can be supplemented with the second clutch unit 152-2 according to FIG. 3. In FIG. 5 and in FIG. 6, this second clutch unit 152-2 then basically has the same relative arrangement with respect to the rotor drive shaft 154 and the modulation ring 62 as in the embodiment according to FIG. 3. In FIG. 5 and in FIG. 6, this second clutch unit 152-2 then forms in each case, together with the clutch device 164, the functionality of the start-up module 150 according to FIG. 3. In this way, the clutch device 164 according to FIG. 5 and according to FIG. 6 in each case obtains a dual function and can contribute in a component-saving manner to the implementation of the functionality of a start-up module 150 in the transmission device 40 according to FIG. 5 and according to FIG. 6.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A transmission arrangement for a drivetrain of an agricultural towing vehicle, comprising an input shaft, an output shaft, a transmission device, and a transmission unit which is arranged downstream in the power flow and which comprises a first transmission input shaft and a second transmission input shaft, wherein the transmission device includes a mechanical transmission branch and a variable transmission branch with a magnetic-electrical epicyclic transmission stage comprising an internal rotor, an external stator and an interposed rotatable magnetic modulation ring, electrical power of an electric machine coupled to the input shaft being able to be transmitted to the stator of the epicyclic transmission stage, the stator of the epicyclic transmission stage being able to be actuated to achieve a rotation of the modulation ring, and a coupling device having a planetary transmission being arranged between the modulation ring and the two transmission input shafts in such a way that the modulation ring is rotationally conjointly connected to a planet wheel carrier of the planetary transmission, the planet wheel carrier is rotationally conjointly connected or connectable in terms of drive to the first transmission input shaft and a first sun wheel of the planetary transmission is rotationally conjointly connected or connectable in terms of drive to the second transmission input shaft.

2. The transmission arrangement of claim 1, wherein a second sun wheel of the planetary transmission is rotationally conjointly connected to the input shaft, the planet wheel carrier carries planet wheels of the planetary transmission, the first transmission input shaft and the planet wheel carrier are connectable in terms of drive via a clutch, or the second transmission input shaft and the first sun wheel of the planetary transmission are connectable in terms of drive via another clutch.

3. The transmission arrangement of claim 1, wherein a transmission stage for reversing a direction of rotation is arranged between the input shaft and the magnetic-electrical epicyclic transmission stage.

4. The transmission arrangement of claim 3, wherein the transmission stage for reversing a direction of rotation comprises a planetary transmission.

5. The transmission arrangement of claim 4, wherein the transmission stage for reversing a direction of rotation comprises a clutch device positioned upstream of the planetary transmission.

6. The transmission arrangement of claim 1, wherein a start-up module for electric start-up is arranged between the input shaft and the magnetic-electrical epicyclic transmission stage, the start-up module being configured for the selective coupling and decoupling of a drive connection between the input shaft or the electric machine and the magnetic-electrical epicyclic transmission stage.

7. The transmission arrangement of claim 6, wherein the start-up module comprises:
a first clutch unit which is drive-connected to the input shaft or to the electric machine on the drive side and is rotationally conjointly connected to the rotor of the magnetic-electrical epicyclic transmission stage by way of a rotor drive shaft on the output side, or
a second clutch unit which along the power flow is rotationally conjointly connected on one side to the rotor of the magnetic-electrical epicyclic transmission stage by way of a rotor drive shaft and is rotationally conjointly connected on the other side to the modulation ring.

8. The transmission arrangement of claim 7, wherein that the first clutch unit of the start-up module which is drive-connected to the input shaft or to the electric machine on the drive side is effective as the clutch device, which is part of the transmission stage for reversing a direction of rotation arranged between the input shaft and the magnetic-electrical epicyclic transmission stage.

9. The transmission arrangement of claim 1, wherein the transmission unit has at least four gear sets for establishing gear ratio stages, and fixed wheels of the gear sets are rotationally conjointly arranged on the first transmission input shaft and the second transmission input shaft.

10. The transmission arrangement of claim 9, wherein shift wheels of the gear sets are rotatably mounted on the output shaft, a first gear set and a second gear set each have the fixed wheel on the first input shaft and each have the shift wheel on the output shaft, and a third gear set and a fourth gear set each have the fixed wheel on the second transmission input shaft and each have the shift wheel on the output shaft.

11. The transmission arrangement of claim 10, wherein a shift element for coupling two shift wheels is provided, the shift wheel of the second gear set and the shift wheel of the third gear set being able to be selectively coupled to the shift element in such a way that at least one winding path gear ratio stage is able to be formed via the second and the third gear set.

12. The transmission arrangement of claim 11, wherein the shift element is movable between a first shift position, in which the shift wheel of the second gear set and the shift wheel of the third gear set are coupled, and a second shift position, in which the shift wheel of the second gear set and the shift wheel of the third gear set are released from one another.

13. The transmission arrangement of claim 10, wherein the transmission unit comprises one or more coupling elements, the shift wheels being able to be rotationally conjointly and releasably connected to the output shaft by one of the coupling elements.

14. The transmission arrangement of claim 1, wherein the transmission unit comprises six gear ratio stages or the first and the sixth gear are implemented as a winding path gear ratio stage.

15. An agricultural towing vehicle comprising a transmission arrangement including: an input shaft, an output shaft, a transmission device, and a transmission unit which is arranged downstream in the power flow and which comprises a first transmission input shaft and a second transmission input shaft, wherein the transmission device includes a mechanical transmission branch and a variable transmission branch with a magnetic-electrical epicyclic transmission stage comprising an internal rotor, an external stator and an interposed rotatable magnetic modulation ring, electrical power of an electric machine coupled to the input shaft being able to be transmitted to the stator of the epicyclic transmission stage, the stator of the epicyclic transmission stage being able to be actuated to achieve a rotation of the modulation ring, and a coupling device having a planetary transmission being arranged between the modulation ring and the two transmission input shafts in such a way that the modulation ring is rotationally conjointly connected to a planet wheel carrier of the planetary transmission, the planet wheel carrier is rotationally conjointly connected or connectable in terms of drive to the first transmission input shaft and a first sun wheel of the planetary transmission is rotationally conjointly connected or connectable in terms of drive to the second transmission input shaft.
